(19) United States
(12) Patent Application Publication
(10) Pub. No.: US 2025/0104012 A1
(43) Pub. Date: Mar. 27, 2025

(54) Inventory Management System

(71) Applicant: Streamline Electronics Manufacturing, Inc., Fremont, CA (US)

(72) Inventor: Kazim Jafri, Fremont, CA (US)

(21) Appl. No.: 18/783,373

(22) Filed: Jul. 24, 2024

Related U.S. Application Data
(60) Provisional application No. 63/468,656, filed on May 24, 2023.

(51) Int. Cl. G06Q 10/087; F21S 4/28; F21V 23/00; F21Y 113/00; F21Y 115/10; G08B 7/06

(52) U.S. Cl. CPC G06Q 10/087; F21S 4/28; F21V 23/003; F21Y 2113/00; F21Y 2115/10; G08B 7/06

(57) ABSTRACT

An inventory management system may comprise first and second storage locations each having a unique identifier; LED strip lights having at least one light spatially associated with the first storage location and one light spatially associated with the second storage location; a database for storing storage locations for one or more items; and a control system for receiving a request for a first item, determining based on a database query that the first item is stored in the first storage location, and illuminating the light associated with the first storage location.

### CROSS-REFERENCE TO RELATED APPLICATIONS

This application claims priority to U.S. provisional application No. 63/468,656, filed on May 24, 2023, titled “Inventory Management System,” the first inventor of which is Kazim Jafri, and the entirety of which is incorporated herein by reference.

### BACKGROUND OF THE INVENTION

Industrial factories, assembly lines, and/or other facilities may store, use, and manage inventories of many parts. These parts may have different sizes ranging from very small to large. A frequent challenge in such environments is picking parts quickly and accurately, maintaining an inventory database tracking the location and quantity of parts, and additionally tracking when (and where) a part is added or removed. Currently available inventory management systems can be expensive.

What is needed is an inventory management system that is economical, facilitates quick access for picking and putting parts, and facilitates accuracy for tracking part quantity and location.

### BRIEF SUMMARY OF THE INVENTION

z,999

### BRIEF DESCRIPTION OF THE DRAWINGS

FIG. 1 shows an exemplary IMS using LED lights and hanging bags.

FIG. 2 shows an exemplary IMS using LED lights and hanging bags.

FIG. 3 shows an exemplary IMS using LED lights and hanging bags.

FIG. 4 shows an exemplary IMS using LED lights and hanging bags.

FIG. 5 shows an exemplary IMS using LED lights and hanging bags.

FIG. 6 shows an exemplary IMS using LED lights and hanging bags.

FIG. 7 shows an exemplary IMS using LED lights and hanging bags, with some but not all LED location lights illuminated.

FIG. 8 shows an interface for a software system for an exemplary IMS.

FIG. 9 shows an interface for a software system for an exemplary IMS.

FIG. 10 shows two screens showing software interfaces for a software system for an exemplary IMS.

FIG. 11 shows an interface for a software system for an exemplary IMS.

FIG. 12 shows an interface for a software system for an exemplary IMS.

FIG. 13 shows an interface for a software system for an exemplary IMS.

FIG. 14 shows an interface for a software system for an exemplary IMS.

FIG. 15 shows an interface for a software system for an exemplary IMS.

FIG. 16 shows an exemplary IMS using LED lights and hanging bags, with at least one LED location light illuminated.

FIG. 17 shows an exemplary IMS using LED lights and hanging bags, with at least one LED location light illuminated.

FIG. 18 shows an exemplary IMS using LED lights and hanging bags, with no LED location lights illuminated.

FIG. 19 shows a close-up of monitors assigned to each shelf for an exemplary IMS.

FIG. 20 shows a dimmed view of an exemplary IMS using LED lights and hanging bags, with multiple LED location lights illuminated.

FIG. 21 shows a dimmed view of an exemplary IMS using LED lights and hanging bags, with multiple LED location lights illuminated, some in process of lighting up.

FIG. 22 shows a dimmed view of an exemplary IMS using LED lights and hanging bags, with all LED location lights on the right side of the aisle being illuminated, and none of the LED location lights on the left side of the aisle being illuminated.

FIG. 23 shows an undimmed view of an exemplary IMS using LED lights and hanging bags, with all LED location lights on the right side of the aisle being illuminated, and none of the LED location lights on the left side of the aisle being illuminated.

FIG. 24 shows a dimmed view of an exemplary IMS using LED lights and hanging bags, with all LED location lights illuminated.

FIG. 25 shows an interface for a software system for an exemplary IMS, specifically a report successfully locating parts with extra options.

FIG. 26 shows an interface for a software system for an exemplary IMS, specifically settings to begin a session.

FIG. 27 shows an interface for a software system for an exemplary IMS, specifically work-order kit-pulling setup and the corresponding processing report with extra information on each individual part.

FIG. 28 shows an interface for a software system for an exemplary IMS, specifically work-order history report.

FIG. 29 shows an interface for a software system for an exemplary IMS, specifically a component history report.

FIG. 30 shows an interface for a software system for an exemplary IMS, specifically one of the menus with extra options and future report placeholders.

FIG. 31 shows an interface for a software system for an exemplary IMS, specifically the login popup.

FIG. 32 shows an interface for a software system for an exemplary IMS, specifically the menu to create a new part.

FIG. 33 shows an interface for a software system for an exemplary IMS, specifically the menu to locate one or many parts.

### DETAILED DESCRIPTION OF THE INVENTION

An inventory management system (“IMS”) may comprise storage hardware (e.g., shelves, bins, hanging bags), a visual identification system for identifying part locations (e.g., LED strip lights), a database for tracking part location and quantity, and one or more computer controllers for interfacing with the database, storing information about part location and quantity, and for controlling and/or interfacing with the visual identification system. The IMS may additionally comprise a user interface (e.g., touchscreen, keyboard, scanner, RFID sensors) for a user to (i) input information (or to detect information) about removal of parts, addition of parts, and/or changes in the storage scheme (e.g., addition of new shelves, bins, hanging locations, movement of such, etc.) or to (ii) elicit information, e.g., about the storage location of a part.

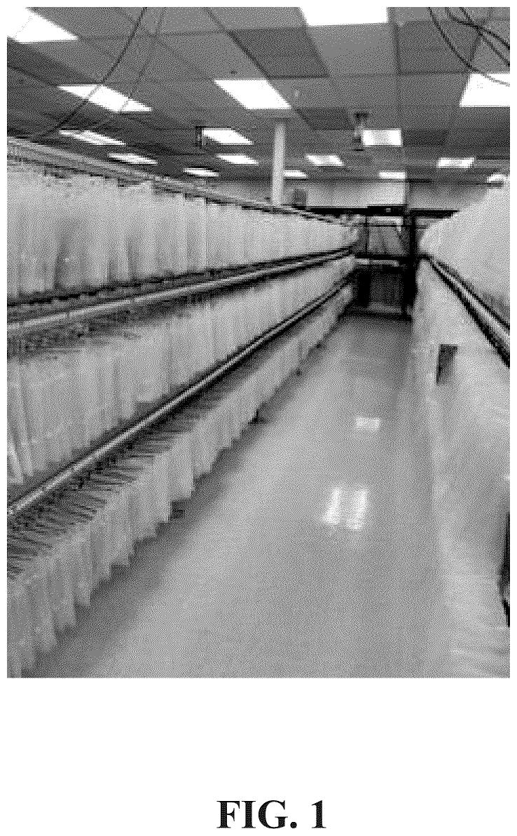

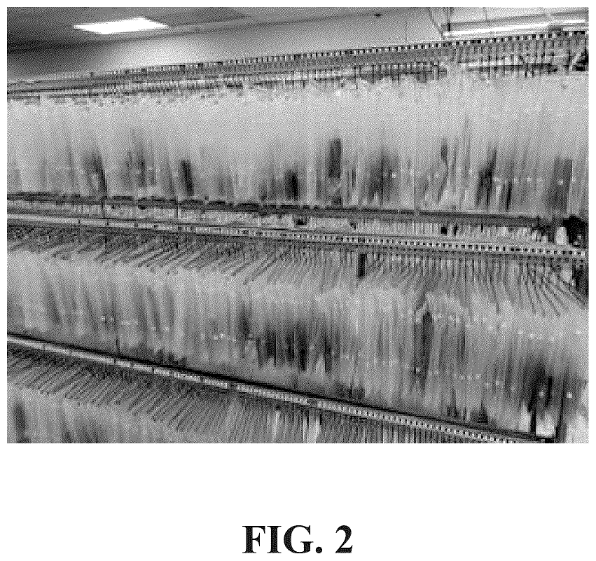

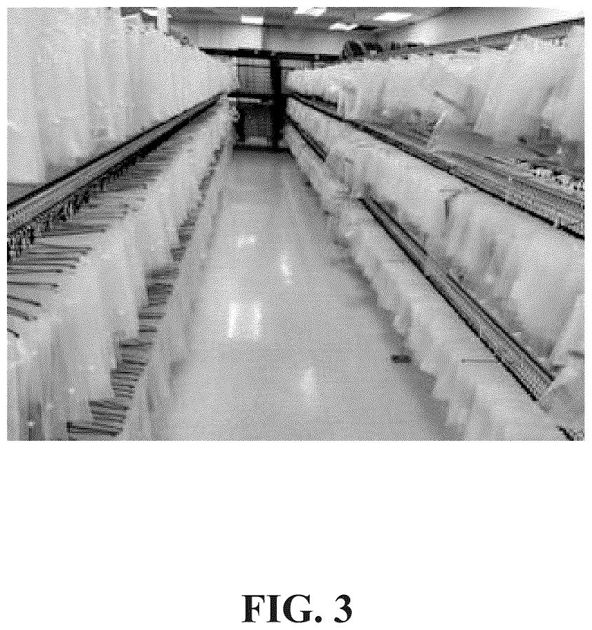

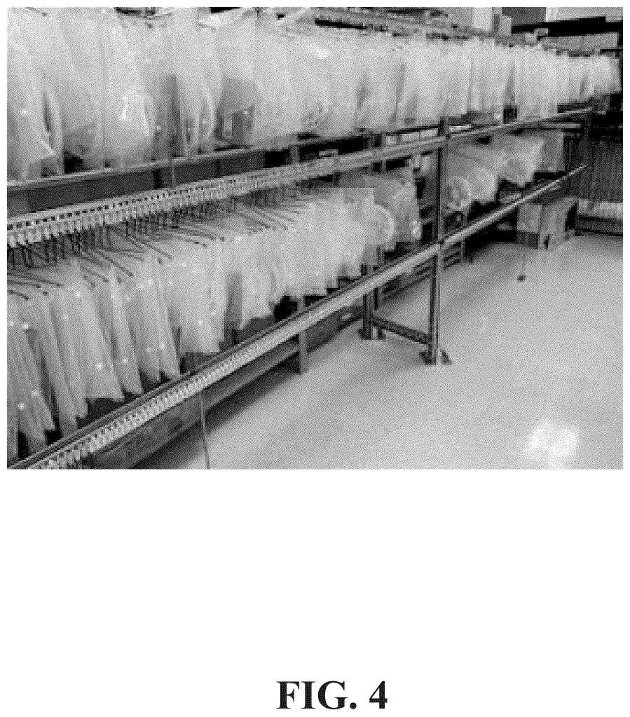

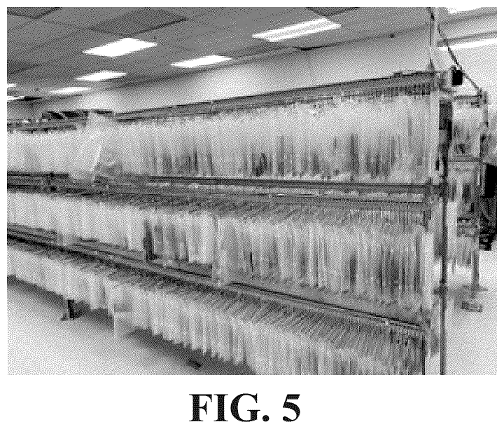

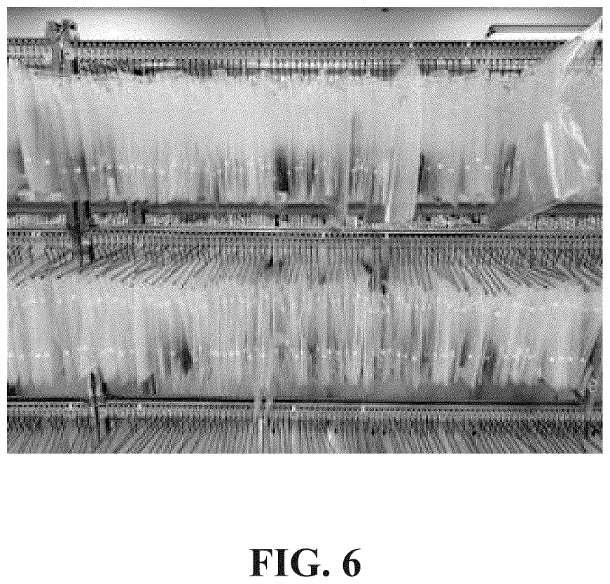

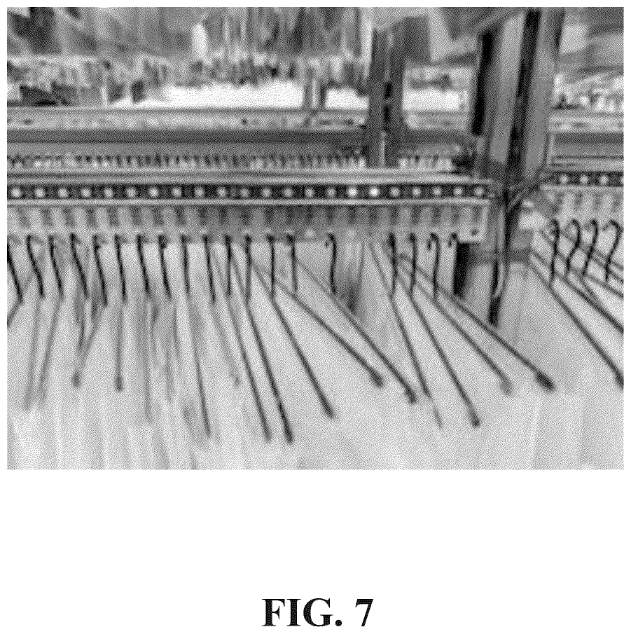

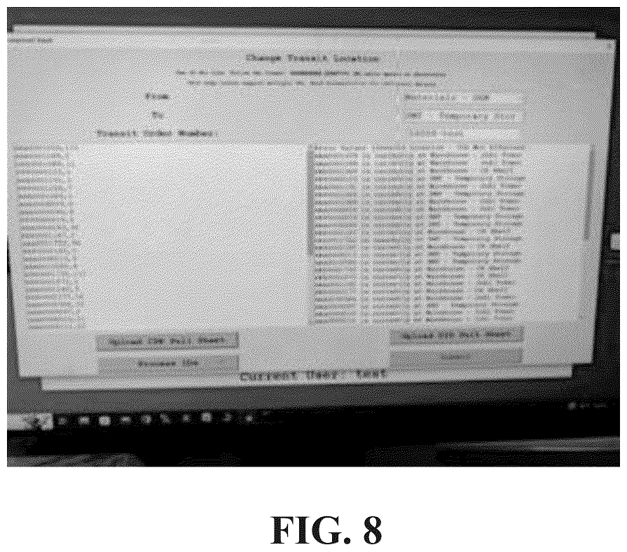

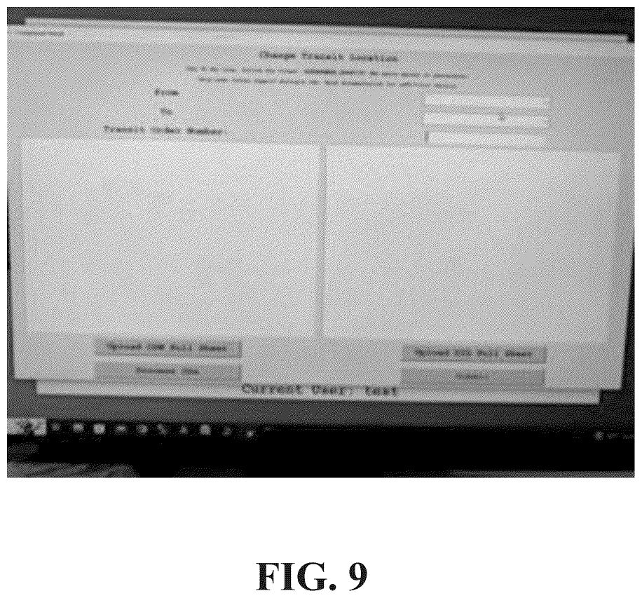

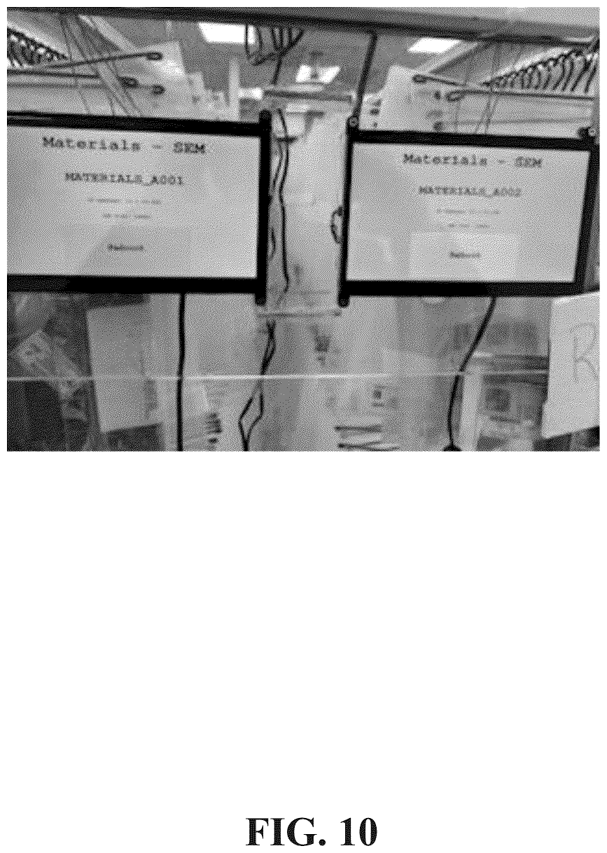

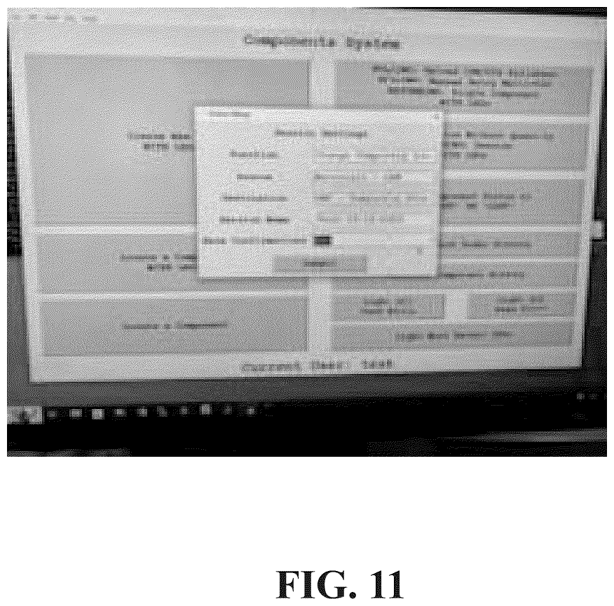

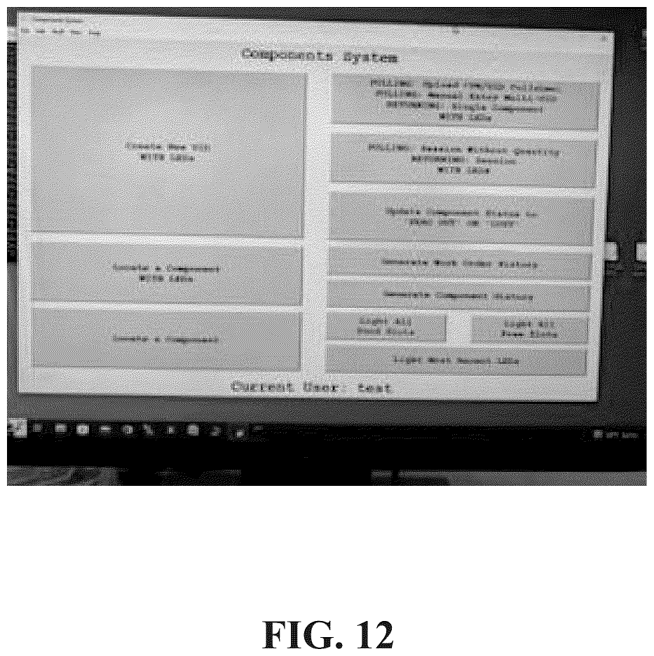

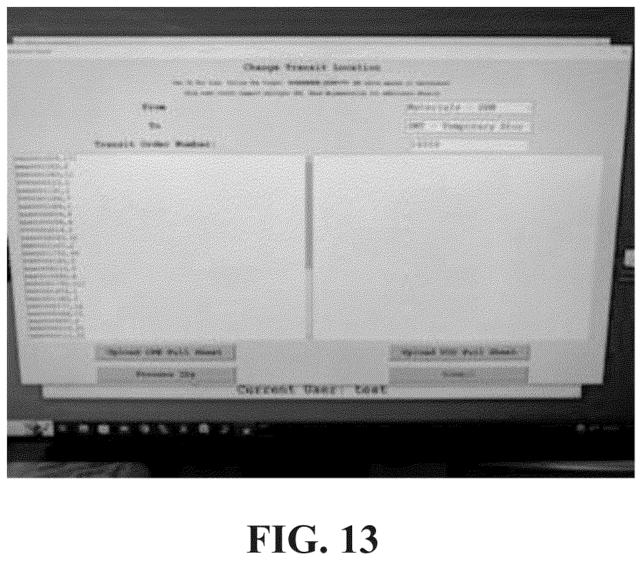

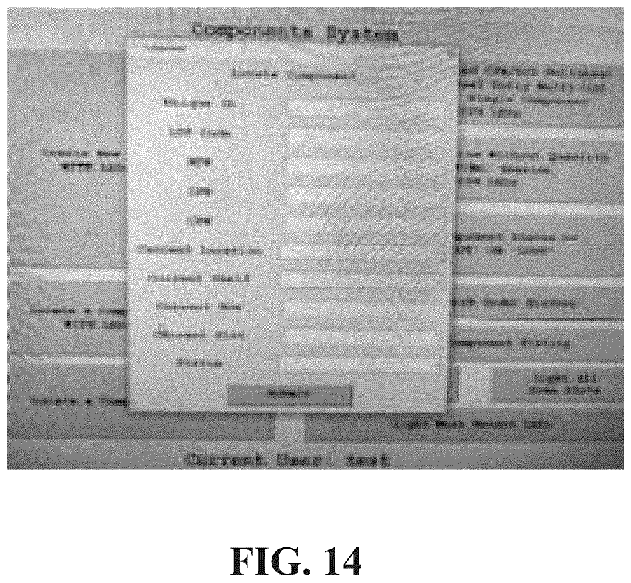

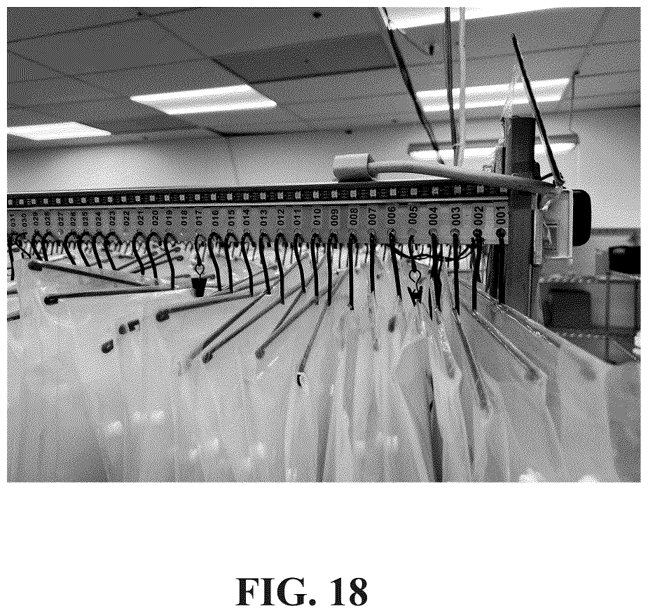

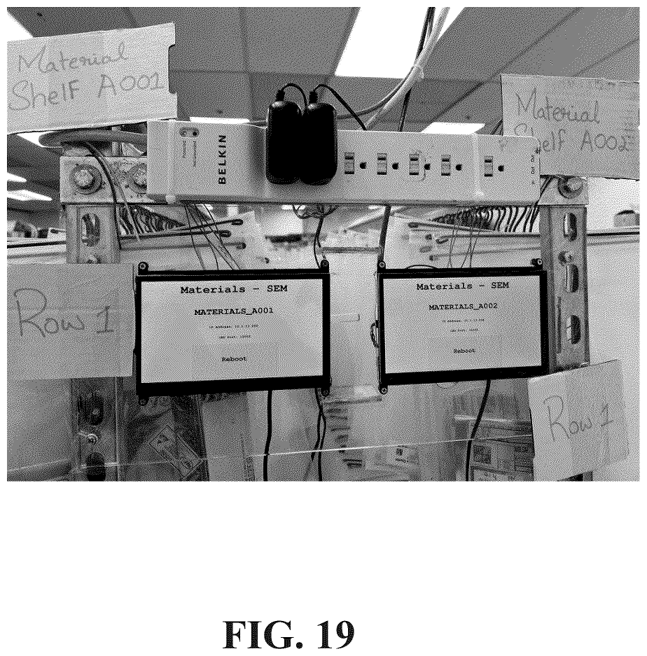

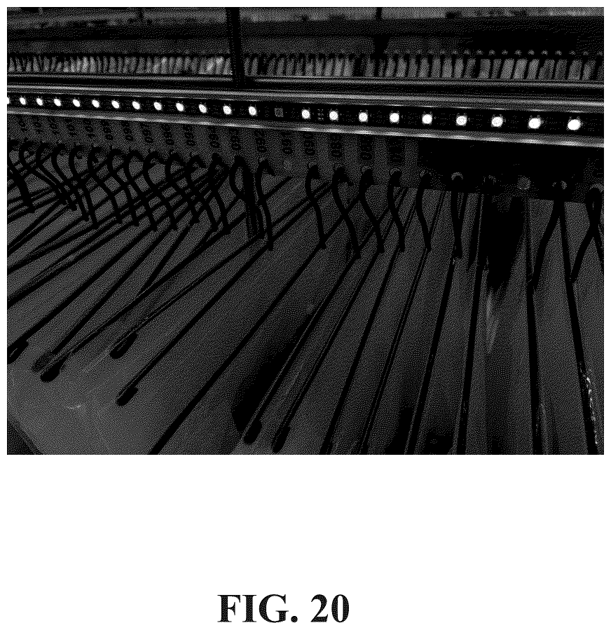

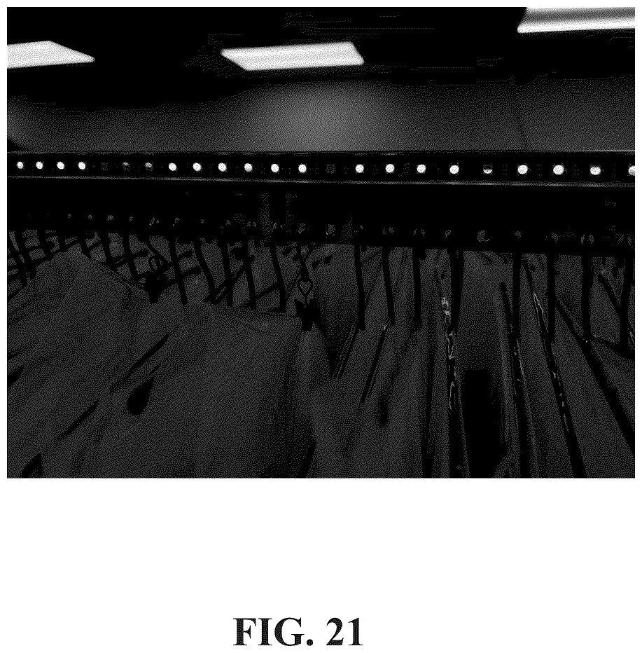

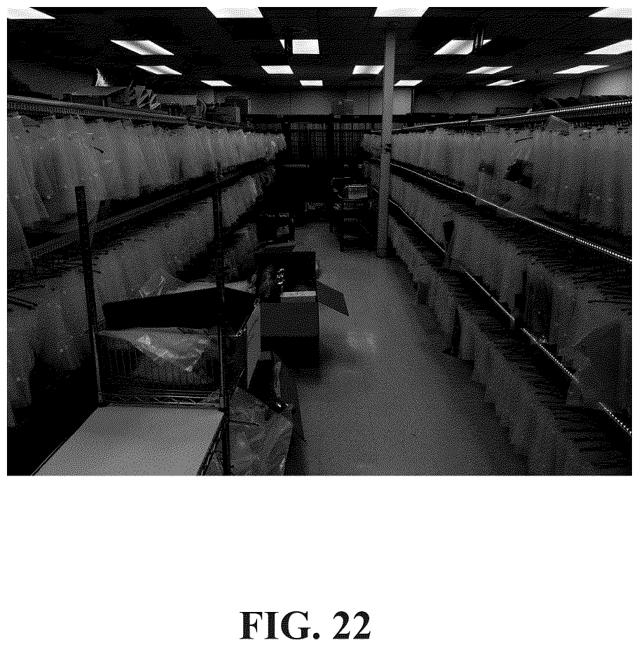

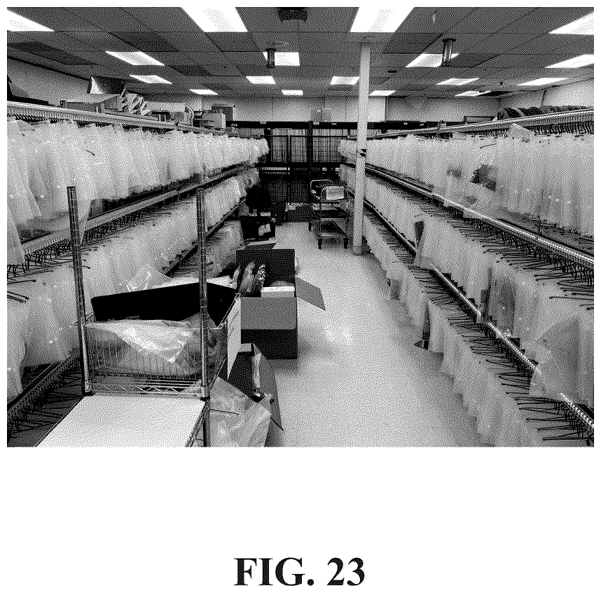

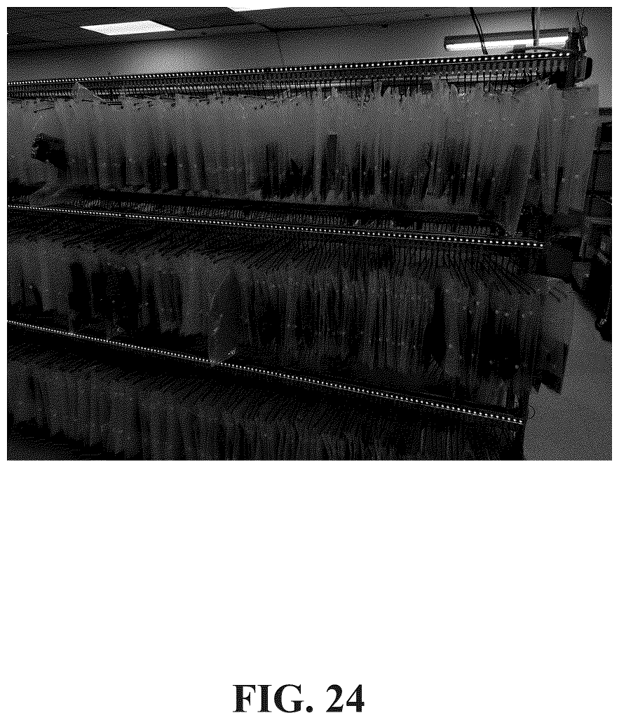

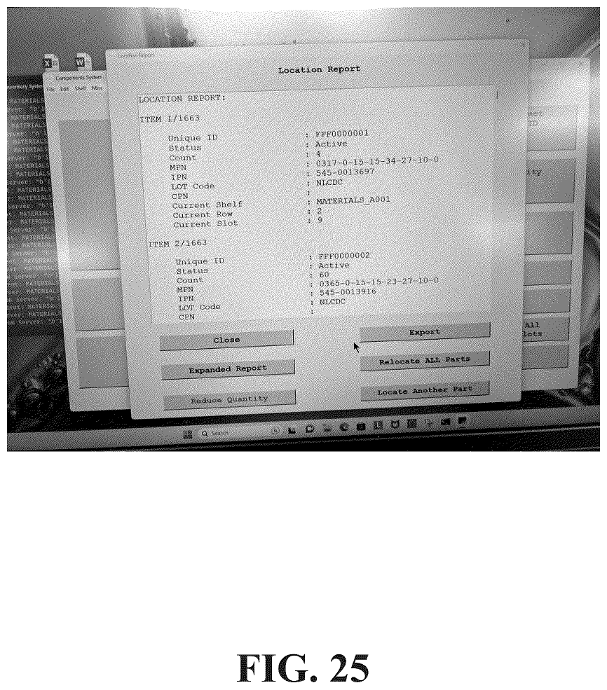

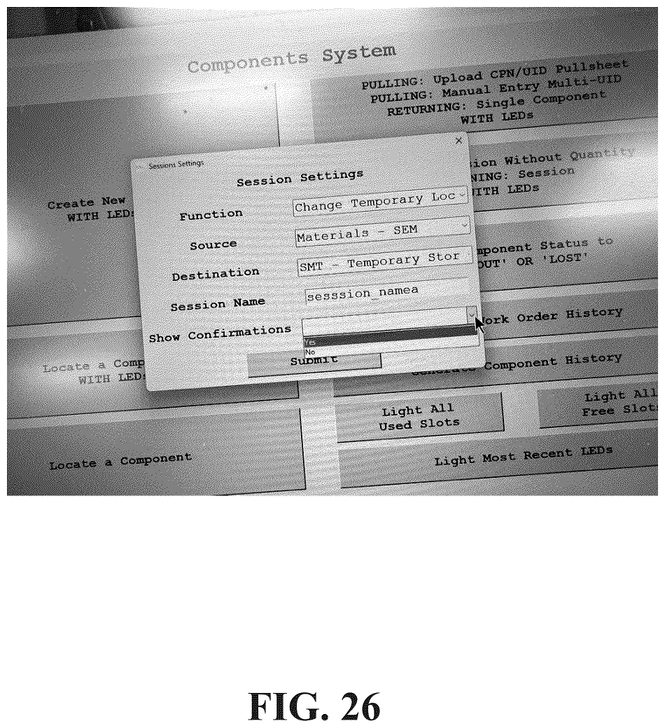

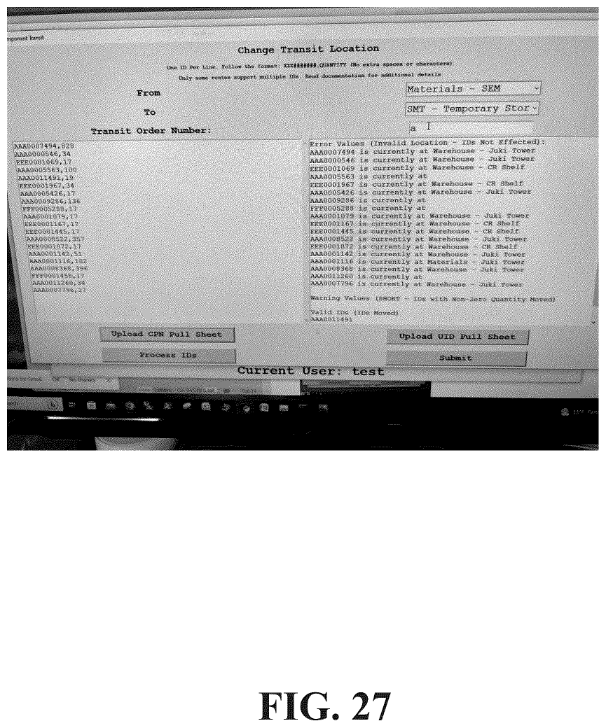

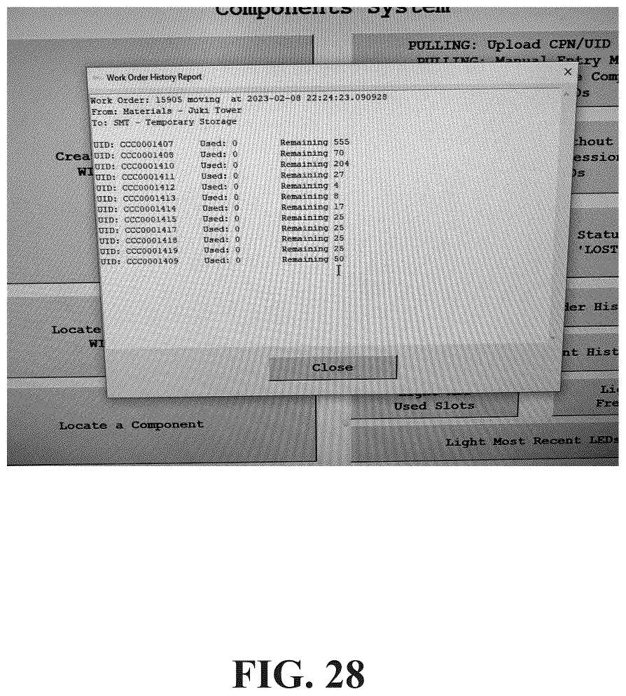

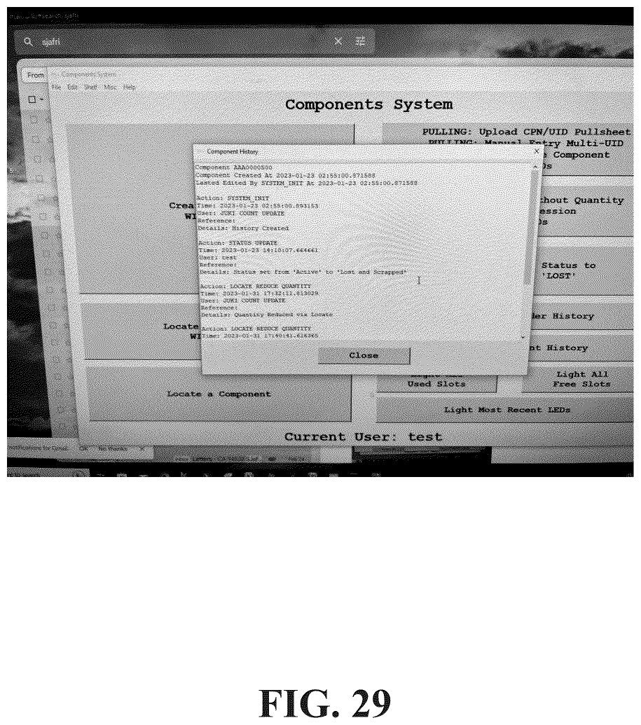

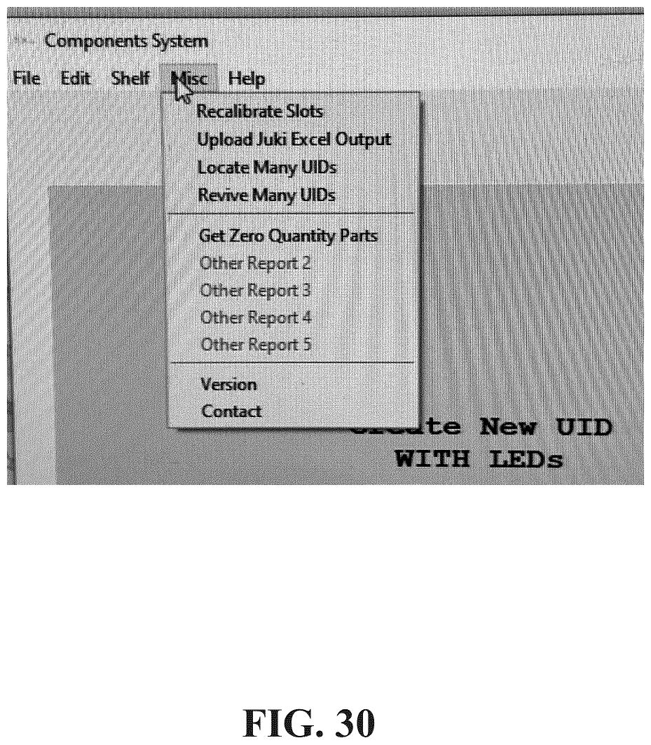

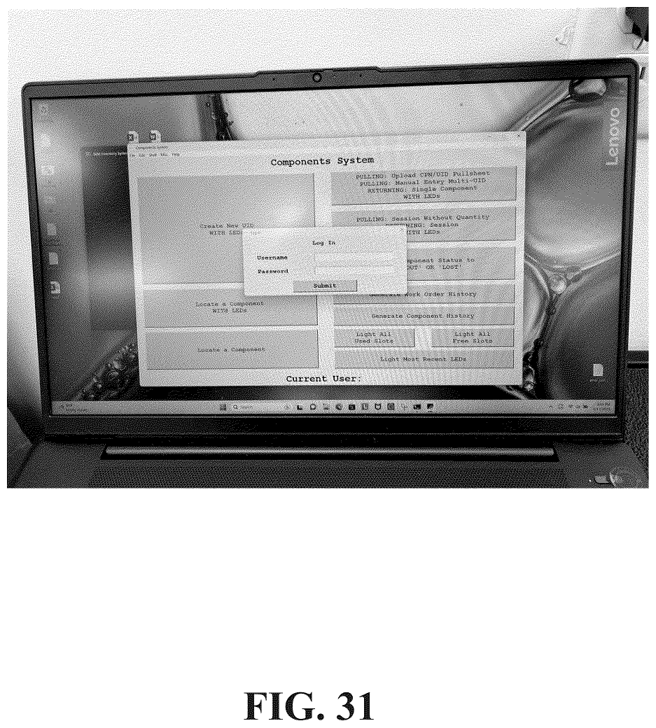

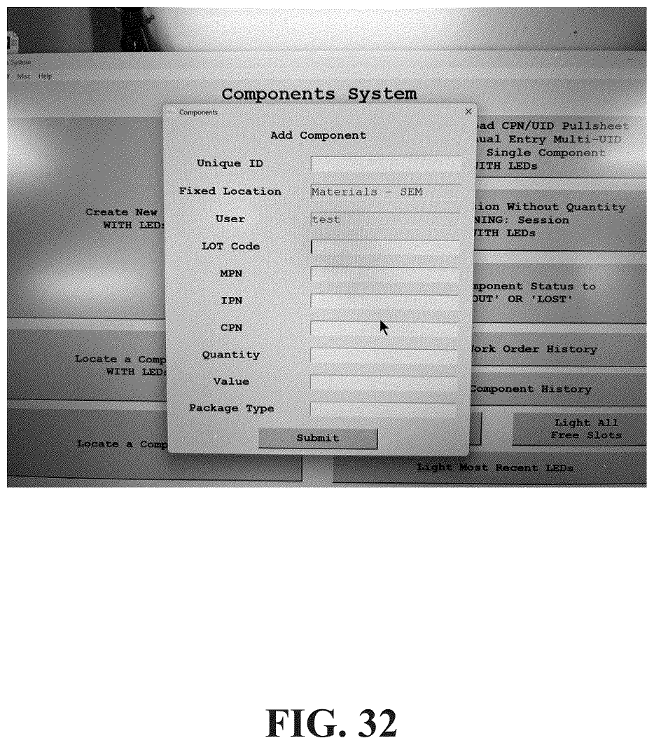

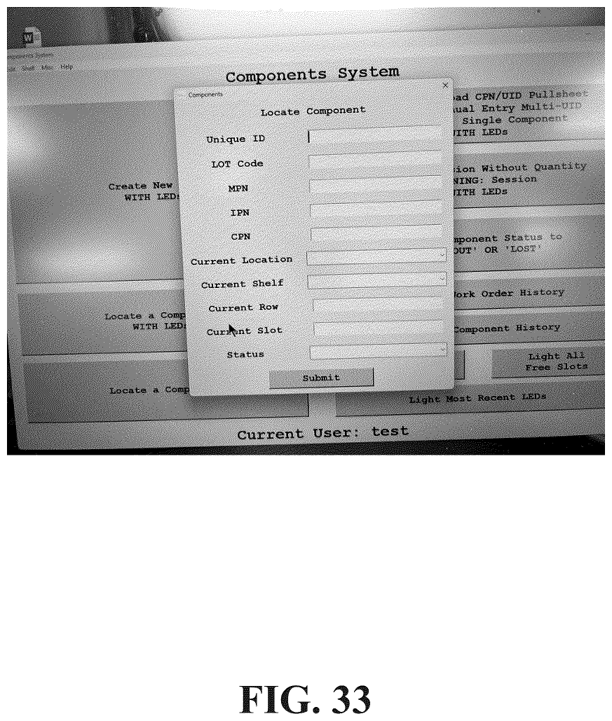

FIGS. 1-33 show an exemplary IMS using hanging bags and LED strip lights. When used with hanging bags, the inventory storage system may comprise a hole or other hanging mechanism on which one or more bags may be hung. Such hole or other hanging mechanism may constitute a “location.” In one embodiment, a storage location may be references as a unique row, shelf, and “slot.” The slot may refer to the hole where the bag is hung.

In one embodiment, LED strip lights may be used to mark and/or visually identify storage locations. For example, for hanging bags, LED strip lights may be placed on the hanging hardware. The LED strip lights may correspond with the holes for hanging bags or other mechanical system for hanging or otherwise storing hanging bags (other any other container using a hanging system). LED strip lights are economical and each light may be uniquely identifiable/addressable and controllable. Controlling one or more light in the LED strip lights may include changing the color, brightness, and/or temporal pattern (e.g., fading, blinking, etc.).

Mounts for LED strip lights are also available and may be used for mounting strip LEDs for hanging hardware, shelves, bins, and/or other storage hardware.

In another embodiment, inventory is stored on shelves with smaller items inside a bin or drawer. In some embodiments, inventory is stored on the floor due to weight or large size of the item.

Inventory may be stored across multiple shelving units. Each shelving unit may have its own unique location identifier, a corresponding microcomputer, and a visual indicator, e.g., an LED on the end of the shelving unit. Within a shelving unit, there may be any number of shelves. Each of the shelves may have LEDs along the exterior edge of the shelf. The LEDs are connected to the shelving unit microcontroller. For each item of inventory stored at/on one or more shelf locations, the system may store an identifier of the shelf location (e.g., row, shelf, slot) and may also store addressing/identification/control information for one or more LED lights associated with the location.

In one embodiment, a user may request from the IMS the location of a specific part. The IMS may respond by providing a location identifier, as well as by providing a visual guide by lighting one or more lights, e.g., one or more LED strip lights that spatially identify the location where the requested part is located. The LED lights (or other visual identifiers) may be controlled by a controller over a wired connection, Wi-Fi, Bluetooth, or any other communication/control technology known in the art. In one embodiment, a single controller may control a set of storage locations, e.g., one shelf or one row or aisle of hanging bags.

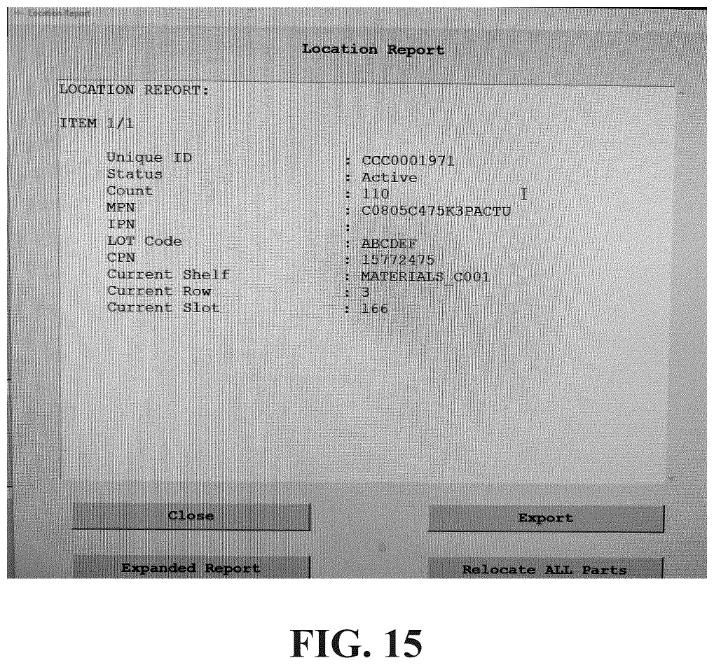

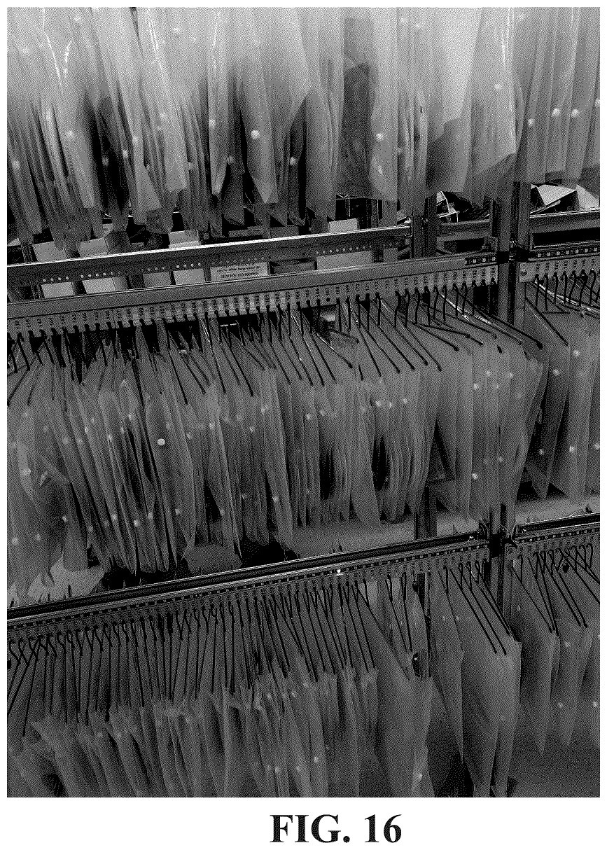

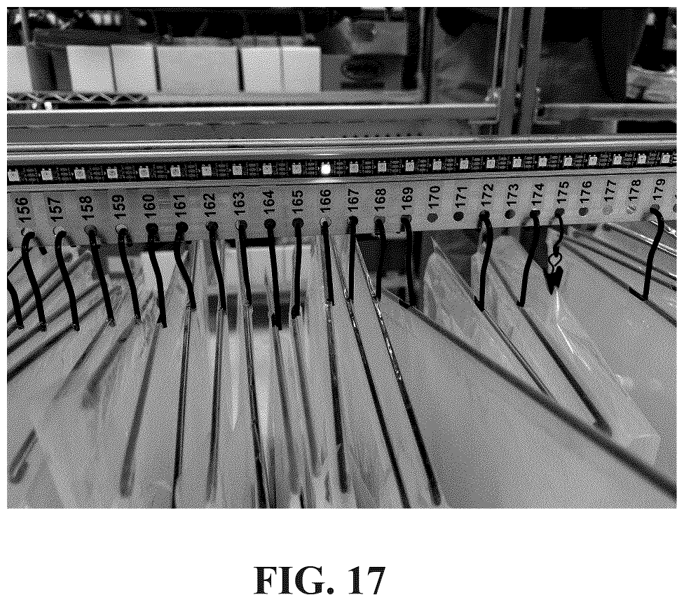

FIGS. 1-33 show an exemplary embodiment in which the IMS provides a location identifier and a light to guide a user to a storage location. FIG. 15 shows an exemplary user interface for a “Location Report” for a user's search for an item having unique ID “CCC0001971.” The Location Report indicates that this item is located at shelf “MATERIALS_C001,” row “3,” and slot “166.” As shown in FIGS. 16 and 17, the IMS may use a LED light to identify slot “166” and thereby visually guide the user to the physical location of the desired item/part.

In another embodiment, the system may guide a user to the physical location of a part by using a monitor (e.g., showing an image of a map or other diagram to direct to the storage location), a roof projection (e.g., a light such as a laser or other directable light originating from a ceiling or other high location that points to a storage location or a path to the storage location), a noise indicator (e.g., using a noise that originates from a storage location or that identifies the storage location or a path to the storage location), or any other visual or audio indicator that may guide a user to a storage location, a path to a storage location, and/or an area in a facility where the storage location is located.

When a user removes a part from the identified location, the user may scan the part (e.g., bar code, QR code, RFID, etc.) using a scanner, sensor, or other scanning hardware that may report to the system that a part has been removed. In some embodiments each location may also have a bar code, QR code, RFID, or other identifier that may be scanned in conjunction with scanning a part. A similar operation may be performed for putting a part in a location. The scanner may be in communication with a controller to update the database regarding the removed or added part.

### Multiple Users

In one embodiment, the inventory management system may support multiple concurrent users. For example, the LED light strands may be multi-colored. A first user's parts may be identified using red LEDs; a second user's parts may be identified using blue LEDs.

### RF Hardware Interactions

In one embodiment, the inventory management system may be connected to RF hardware within the facility. For example, each part may have an RF tag and multiple RF detectors are installed throughout the facility. As a part is moved through different areas of the facility, RF sensors can track the part's location unless or until an RF sensor has been removed.

What is claimed is:

1. A system, comprising:
a first storage location having a first storage location identifier;
a second storage location having second storage location identifier;
location signaling hardware for providing a human-perceivable signal to identify a storage location; and
a control system, comprising:
a database for storing a storage location identifier for each of at least a first item and a second item;
a search interface for receiving a request for a storage location for a search item and for determining, based on querying the database, that the search item is stored in the first storage location; and
a signaling hardware interface module configured to direct the location signaling hardware to provide a human-perceivable signal to identify the first storage location.

2. The system of claim 1, wherein the first storage location is a first hanging location and the second storage location is a second hanging location.

3. The system of claim 1, wherein the first storage location is a first bin and the second storage location is a second bin.

4. The system of claim 1, wherein the first storage location is a first drawer and the second storage location is a second drawer.

5. The system of claim 1, wherein the location signaling hardware comprises a first LED that is spatially associated with the first storage location and a second LED that is spatially associated with the second storage location.

6. The system of claim 1, wherein the location signaling hardware comprises LED strip lights having at least a uniquely addressable first light from the LED strip lights that is spatially associated with the first storage location and a uniquely addressable second light from the LED strip lights that is spatially associated with the second storage location.

7. The system of claim 6, wherein the signaling hardware interface module is configured to direct the LED strip lights to activate the first light from the LED strip lights that is spatially associated with the first storage location.

8. The system of claim 7, wherein activating the first light from the LED strip lights comprises at least one from the following list: solid illumination, color change, brightness change, and temporal pattern.

9. The system of claim 6, wherein the LED strip lights are mounted on a LED strip light mount.

10. The system of claim 1, wherein the location signaling hardware comprises an audio indicator configured to identify the first storage location.

11. A system, comprising:
a first storage location having a first storage location identifier;
a second storage location having second storage location identifier;
location signaling hardware comprising LED strip lights having at least a uniquely addressable first light from the LED strip lights that is spatially associated with the first storage location and a uniquely addressable second light from the LED strip lights that is spatially associated with the second storage location; and
a control system, comprising:
a database for storing a storage location identifier for each of at least a first item and a second item;
a search interface for receiving a request for a storage location for a search item and for determining, based on querying the database, that the search item is stored in the first storage location; and
a signaling hardware interface module configured to direct the LED strip lights to activate the first light from the LED strip lights that is spatially associated with the first storage location.

12. The system of claim 11, wherein activating the first light from the LED strip lights comprises at least one from the following list: solid illumination, color change, brightness change, and temporal pattern.

13. The system of claim 12, wherein activating the first light from the LED strip lights comprises solid illumination.

14. The system of claim 12, wherein activating the first light from the LED strip lights comprises a temporal blinking pattern.

15. A method, comprising:
storing in a database an association between a first storage location identifier and a first item;
storing in the database an association between a second storage location identifier and a second item;
receiving a request for the first item;
determining, based on querying the database, that the first item is stored in the first storage location;
based on the determination that the first item is stored in the first storage location, directing a signaling hardware interface module to activate a uniquely addressable first light from LED strip lights, wherein the uniquely addressable first light is spatially associated with the first storage location.
